(19) United States
(12) Patent Application Publication
(10) Pub. No.: US 2010/0175304 A1
(43) Pub. Date: Jul. 15, 2010

(54) FISHING LURE

(76) Inventor: Thomas C. Barmore, Addisson, IL (US)

Correspondence Address: L.C. BEGIN & ASSOCIATES, PLLC, 510 HIGHLAND AVENUE, PMB 403, MILFORD, MI, 48381, US

(21) Appl. No.: 12/688,707

(22) Filed: Jan. 15, 2010

Related U.S. Application Data
(60) Provisional application No. 61/144,782, filed on Jan. 15, 2009.

(51) Int. Cl. A01K 85/01; A01K 85/00

(52) U.S. Cl. 43/17.6; 43/42.33; 43/42.35; 43/42.28

(57) ABSTRACT

One embodiment of a fishing lure may include a fish-shaped member having at least one hook carried by an outer surface thereof. The fishing lure may further include an electrical unit adapted to be removably received within a hollow compartment of the fish-shaped member. The electrical unit may include a power source, a signaling circuit operative associated with the power source, and a pair of electrical contact elements operatively associated with the signaling circuit and the power source. The pair of electrical contact elements may be capable of operating the signaling circuit based on contact with water.

### CROSS REFERENCE TO RELATED APPLICATION

This application claims the benefit of U.S. Provisional Application No. 61/144,782 filed on Jan. 15, 2009 the disclosure of which is incorporated by reference.

### FIELD OF THE DISCLOSURE

The present disclosure generally relates to fishing equipments, and, more particularly, to a fishing lure.

### BACKGROUND OF THE DISCLOSURE

Fishing is an activity that may be done by both professionals and amateurs. Usually, fishing is done in the open, under varying ambient light conditions, and using various fishing equipments. Conventional fishing equipments include, but are not limited to, hooks, needles, lines, sinkers, floaters, rods, and reels. Further, fishing lures have also been used in connection with fishing.

A fishing lure may be designed to resemble a prey, such as, a small fish. Further, the fishing lure may be intended to attract a fish. Accordingly, a color or design of the fishing lure may be such that the fish gets attracted towards it. Furthermore, other attributes, such as vibration may be imparted on the fishing lure so that the fish gets attracted towards it. The fishing lure may be connected to a free end of a fishing line, and may also include a set of hooks attached thereto.

However, such conventional fishing lures fail to sufficiently attract the fish, especially when ambient light is limited as the fish may be unable to identify the presence of the fishing lures. Moreover, other attributes, such as, vibration, may also fail to sufficiently attract the fish towards the fishing lures.

### SUMMARY OF THE DISCLOSURE

One embodiment of a fishing lure may include a fish-shaped member having at least one hook carried by an outer surface thereof. The fishing lure may further include an electrical unit adapted to be removably received within a hollow compartment of the fish-shaped member. The electrical unit may include a power source, a signaling circuit operative associated with the power source, and a pair of electrical contact elements operatively associated with the signaling circuit and the power source. The pair of electrical contact elements may be capable of operating the signaling circuit based on contact with water.

### BRIEF DESCRIPTION OF THE DRAWINGS

These and other features and advantages of the present disclosure will be apparent from the following detailed description of preferred embodiments and best mode, appended claims, and accompanying drawings in which:

FIG. 1 is a perspective view of one embodiment of a fishing lure;

FIG. 2 is a side view of an electrical unit;

FIG. 3 is a circuit diagram representation of the electrical unit of FIG. 2;

FIG. 4 is a sectional view of the fishing lure of FIG. 1, and

FIG. 5 is a side view of an electrical unit containing a hinged member for circuit activation.

### DETAILED DESCRIPTION OF THE DISCLOSURE

The exemplary embodiments described herein in detail for illustrative purposes are subject to many variations in structure and design. It should be emphasized, however, that the present disclosure is not limited to a particular fishing lure, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The use of “including,” “comprising,” or “having” and variations thereof herein is meant to encompass the items listed thereafter and equivalents thereof as well as additional items. The terms such as “first,” “second,” “outer,” “inner” and other variations thereof as used herein, do not denote an order, elevation or importance, but rather when used signify the presence of at least one of the referenced item. Further, the terms, “a” and “an” herein do not denote a limitation of quantity, but rather denote the presence of at least one of the referenced item.

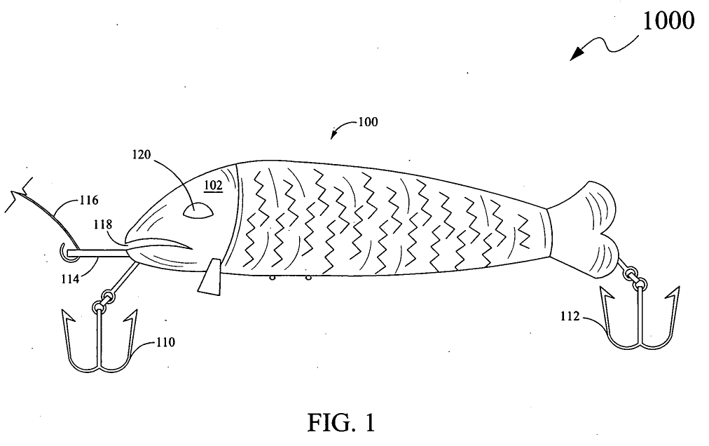

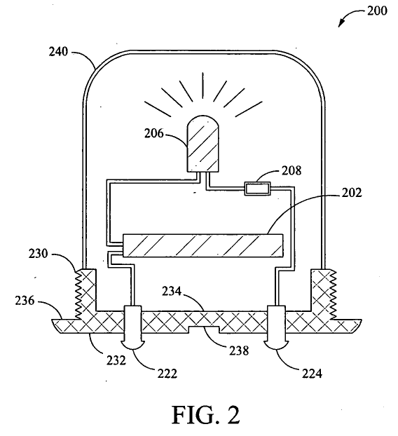

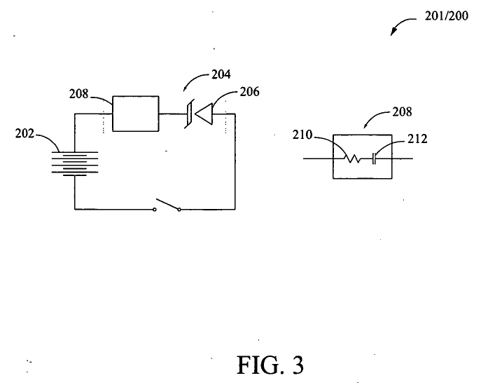

Referring to FIGS. 1-4, one embodiment of a fishing lure 1000 which may be used while capturing an aquatic animal such as a fish (not shown).

The fishing lure 1000 may include a fish-shaped member or housing 100 having an outer surface 102. The fish-shaped member 100 includes a hollow compartment 104 having a threaded opening 106 defined on the outer surface 102 of the fish-shaped member 100. The threaded opening 106 may include thread members 108. The fish-shaped member 100 may further include at least one hook, such as a first hook 110 and a second hook 112 carried by the outer surface 102 of the fish-shaped member 100.

The fish-shaped member 100 may further include an attaching member 114 capable of being connected to a fishing line 116 of a fishing rod (not shown). The connection of the fish-shaped member 100 to the fishing line 116 facilitates movement of the fishing lure 1000 according to desire of a user. Further, the fish-shaped member 100 may include at least one hole such as a first hole 118 and a second hole 120. Each of the first hole 118 and the second hole 120 may be carried by the outer surface 102 of the fish-shaped member 100. More specifically, each of the first hole 118 and the second hole 120 may extend from the outer surface 102 to the hollow compartment 104.

Moreover, the fish-shaped member 100 may be composed of a plastic material. The fish-shaped member 100 may be composed of an opaque material thereby permitting light to exit only through holes 118 and/or 120. Alternatively, the fish-shaped member 100 may be composed of a transparent material. The fish-shaped member 100 may also be composed of an acrylic material. Even further, the fish-shaped member 100 may be formed from metal such as aluminum or steel, or from some other suitable material. Or, the fish-shaped member 100 may be formed from a composite material containing metal and a polymeric material such as acrylic or plastic. In addition, the fish-shaped member 100 may include a variety of colors and designs, such as, a design and a color of the skin of a fish.

The fishing lure 1000 may further include an electrical unit 200. The electrical unit 200 may be adapted to be removably received within the hollow compartment 104. The electrical unit 200 is shown with the help of its circuit diagram 201. As shown, in the circuit diagram 201, the electrical unit 200 may include a power source 202. The power source 202 may include at least one battery such as a conventional battery. Alternatively, the power source 202 may be at least one rechargeable battery. The electrical unit 200 may further include a signaling circuit 204 operatively associated with the power source 202. The signaling circuit 204 may include, as schematically shown, an illuminator and/or a sound emitter 206 capable of illuminating the surroundings of the fishing lure 1000, and/or of sending out any variant of a desired sound wave emanating from the sound emitter 206. The illuminator 206 may be at least one Light Emitting Diode (LED). These types of circuits with LEDs may be purchased from companies such as Digikey or Radio Shack, for example. Alternatively, the illuminator 206 may be an electrical bulb, or laser light, or other illumination means. Further, the illuminator 206 may be capable of illuminating in a continuous or a blinking pattern. For this purpose, the signaling circuit 204 may further include at least one controller 208 electrically connected to the illuminator and/or sound device 206. The sound emitter or device 206 may be made as described in U.S. Pat. No. 5,214,411 and U.S. Patent Application Publication No. 20090285430, each herein incorporated by reference in their entirety. It will be appreciated that the sound emitted from the sound emitter 206 will be tailored to accommodate sounds that are iteratively determined to attract fish. It should also be understood that in addition to controlling the continuous, intermittent, or blinking pattern of the illuminator or sound device 206, the at least one controller 208 may be capable of controlling other functions of the illuminator or sound device 206. The at least one controller 208 may include at least one resistor 210.

The at least one controller 208 may include at least one resistor 210, and at least one capacitor 212. Moreover, the at least one controller 208 may also include known transistor technology (not shown).

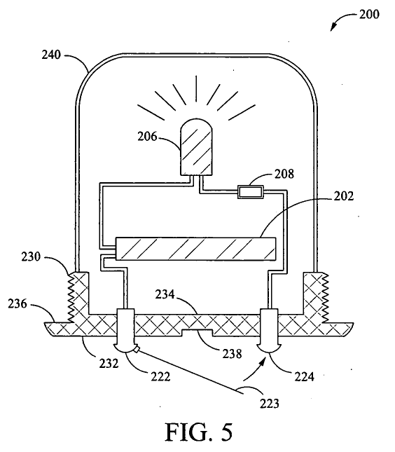

The electrical unit 200 may further include a pair of electrical contact elements, and, more particularly, a first electrical contact element 222 and a second electrical contact element 224. The pair of electrical contact elements 222, 224 may function as a switch for operating the electrical unit 200. Further, the pair of electrical contact elements 222, 224 may be operatively associated with the signaling circuit 204 and the power source 202. The first electrical contact element 222 may be electrically connected to the power source 202 and the second electrical contact element 224 may be electrically connected to the signaling circuit 204. As shown in FIG. 5, either contact element, in this case contact element 222, may if desired include a hinged member 223 made from a conducting material such as metal for contact with an adjoining contact element. It will be appreciated that as the lure is propelled through the water by trolling, reeling, or other means the integral hinge biases the tendency of the hinged member to contact the adjoining contact element 224, thereby completing the circuit. When the lure is not propelled through the water, the circuit is not completed and therefore battery life is prolonged. In the embodiment shown in FIG. 5, contact elements 222 and 224 would be substantially insulated to prevent circuit completion unless hinged member 223 was in contact with both contact elements 222 and 224. For example only, hinged member 223 may be a hook or a flap member made from conductive material.

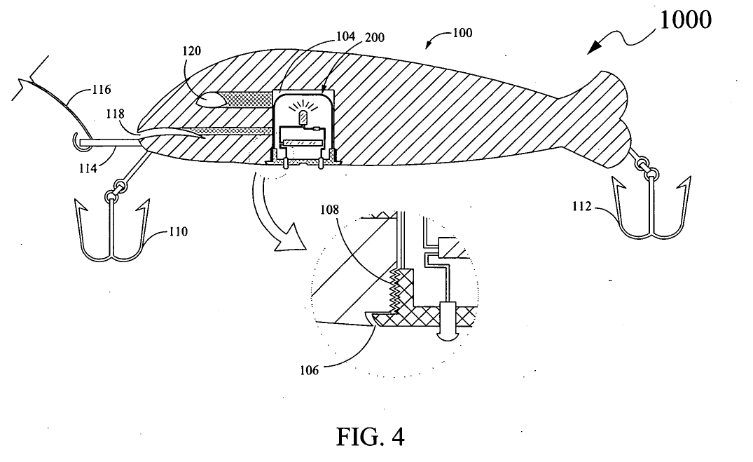

Further, the electrical compartment 200 may also include a base member 230 and a housing member 240 attached to the base member 230. The base member 230 may include an outer side 232, an inner side 234 and a peripheral edge portion 236. The first electrical contact element 222 and the second electrical contact element 224 may be carried by the inner side 234 such that a free end of the first electrical contact element 222 and the second electrical contact element 224 may extend out from the outer side 232 of the base member 230. The base member 230 may further include an engagement slot 238 adapted to receive conventional screws (not shown) for removably attaching the electrical unit 200 to the hollow compartment 104. The housing member 240 may be attached to the inner side 234 of the base member 230. The base member 230 may be composed on a non-conducting material. The peripheral edge portion 236 of the base member 230 may be capable of being attached to the threaded opening 106 of the hollow compartment 104 for removably attaching the electrical unit 200 to the hollow compartment 104. As best shown in FIG. 4, complementary threaded members 238 on the peripheral edge portion 236 of the base member 230 may be threadably attached to the thread members 108 of the threaded opening 106 of the hollow compartment 104, thereby permitting ready exchange of various lighting and/or sound configurations.

Alternatively, the peripheral edge portion 236 of the base member 230 may also be snap fitted to the threaded opening 106 of the hollow compartment 104 for removable attaching. Moreover, other methods may also be used for attaching the base member 230 to the threaded opening 106 without departing from the scope of the present disclosure. The base member 230 and the housing member 240 upon being attached to the threaded opening 106 may preclude water from contacting the power source 202 and the signaling circuit 204. In a preferred embodiment, the housing member 240 when attached to the threaded opening 106 precludes water from contacting the power source 202 and the signaling circuit 204.

It should be understood that the electrical unit 200 may further include other circuits in addition to the signaling circuit 204. For example, the electrical unit 200 may include a sound emitting circuit configured to emit sounds, particularly marine life sounds. The sound emitting circuit may also be operatively associated with the pair of electrical contact elements 222, 224 and the power source 202.

In use, the electrical unit 200 may be received within the hollow compartment 104 of the fish-shaped member 100. The fishing line 118 of a fishing rod may be attached to the attachment member 116. Thereafter, the fishing lure 1000 may be immersed in water. Due to electrical conductivity of water the electrical contact elements 222, 224 complete the circuit of the electrical unit 200. Such completion of the circuit operates the signaling circuit 204. It should be understood that the operation of the signaling circuit 204 thereby illuminates the illuminator 206. Since the fish-shaped member 100 is made up of a transparent material, and additionally because of the presence of the first hole 118 and the second hole 120, the illumination of the signaling circuit 204, and more particularly of the illuminator 206, is visible outside the fish-shaped member 100. However, it should be understood that other methods for electrically connecting the pair of electrical contact elements 222, 224 may also be employed. Moreover, the completion of circuit of the electrical unit 200 may also operate the sound emitting circuit for emitting sound. The illumination either independently or in conjunction with the sound emitted by the fishing lure 1000 results in effectively attracting the fish to bite the fishing lure 1000, thereby assisting the user in capturing the fish.

The present disclosure provides a fishing lure such as the fishing lure 1000, which may be utilized by individuals while fishing. The fishing lure is capable of illuminating its surroundings or transmitting sound waves upon coming in contact with water. This optional illumination or sound propagation saves energy of the power source operating the fishing lure. The illumination of the fishing lure entices the fish to bite the fishing lure thereby becoming hooked. The fishing lure is also capable of producing sound which further assists in attracting the fish about the fishing lure. The fishing lure therefore facilitates a convenient capture of the fish.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A fishing lure comprising:
a housing comprising a hollow compartment, an outer surface, and at least one hook fixed to said outer surface; and
an electrical unit adapted to be removably received within said hollow compartment of the housing, the electrical unit comprising,
a power source,
a signaling circuit operatively associated with the power source, and
a pair of electrical contact elements operatively associated with the signaling circuit and the power source,
wherein the pair of electrical contact elements is capable of operating the signaling circuit based on contact with water.

2. The fishing lure of claim 1, wherein the signaling circuit comprises:
an illuminator capable of illuminating surroundings of the fishing lure; and
at least one controller electrically connected to the illuminator, the at least one controller capable of controlling the illuminator.

3. The fishing lure of claim 2, wherein the illuminator is at least one light emitting diode.

4. The fishing lure of claim 1, wherein said housing is a fish-shaped member, the fish-shaped member further comprising at least one hole carried by the outer surface of the fish-shaped member, the at least one hole capable of transmitting illumination generated by the signaling circuit to surroundings of the fish-shaped member.

5. The fishing lure of claim 4, wherein the fish-shaped member is composed of a transparent material.

6. The fishing lure of claim 4, wherein the fish-shaped member is composed of a plastic material.

7. The fishing lure of claim 4, wherein the fish-shaped member is composed of an acrylic material.

8. The fishing lure of claim 4, wherein the fish-shaped member is composed of a metallic material.

9. The fishing lure of claim 4, wherein the fish-shaped member is composed of a composite material containing metal and a polymer.

10. The fishing lure of claim 1, wherein the electrical unit is threadably attached to the hollow compartment of said housing.

11. The fishing lure of claim 1, wherein the power source includes at least one battery.

12. The fishing lure of claim 1, wherein the electrical unit further comprises a sound emitter operatively associated with the pair of electrical contact elements and the power source.

13. A fishing lure comprising:
a housing comprising a hollow compartment, an outer surface, and at least one hook fixed to said outer surface; and
an electrical unit adapted to be removably received within said hollow compartment of the housing, the electrical unit comprising,
a power source,
a signaling circuit operatively associated with the power source,
a pair of electrical contact elements operatively associated with the signaling circuit and the power source, and
a hinged member attached to one of said electrical contact elements,
wherein upon propelling the lure through water, said hinged member contacts both electrical contact elements of said pair of electrical contact elements.

14. The fishing lure of claim 13, wherein said hinged member is a hook.

15. The fishing lure of claim 13, wherein said hinged member is a flap.
